(19) United States
(12) Patent Application Publication
(10) Pub. No.: US 2005/0144828 A1
(43) Pub. Date: Jul. 7, 2005

(54) Moving wing decoy apparatus and methods

(75) Inventors: Jeffrey S. Lewis, Fort Collins, CO (US); Lance E. Smith, Thornton, CO (US)

Correspondence Address: SANTANGELO LAW OFFICES, P.C., 125 SOUTH HOWES, THIRD FLOOR, FORT COLLINS, CO, 80521, US

(73) Assignee: Dynamic Decoy Technologies , LLC, Fort Collins, CO (US)

(21) Appl. No.: 11/013,618

(22) Filed: Dec. 15, 2004

Related U.S. Application Data
(60) Provisional application No. 60/531,014, filed on Dec. 18, 2003.

(51) Int. Cl. A01M 31/06

(52) U.S. Cl. 43/3

(57) ABSTRACT

Certain embodiments of the invention include moving bird decoy apparatus and related methods that address a bird decoy whose wings may be moved to simulate wing stretching motions exhibited by birds such as geese and ducks. An automated wing motion element together with a power source may be capable of moving decoy wings to simulate wing stretching motions.

### CROSS-REFERENCES TO RELATED APPLICATIONS

This application claims the benefit of and priority to U.S. Provisional Application 60/531014, filed 15 Dec. 2003, entitled “Motorized Wing Flapping Animated Waterfowl Decoy”, hereby incorporated by reference.

### BACKGROUND OF THE INVENTION

Generally, this inventive technology relates to a system for moving decoy wings in order to better attract animals for hunting, viewing or other reasons. Specifically, certain embodiments of the invention focuses on apparatus and methods for moving bird decoy wings (and perhaps the entire bird decoy itself) so as to impart a more life-like appearance to the decoy and thereby enhance the effect of the decoy to attract an animal(s) of interest.

The desire to attract animals has been known for some time, particularly among those who hunt. Decoys can be of help in attracting an animal of interest from an “out-of-range” location to an “in-range” location (perhaps near a hunter's pit or blind) through exploiting the animal of interest's sense of attraction to a certain type of animal mimicked by the decoy, thereby effecting a relocation of the animal of interest to the vicinity of the decoy (typically, the “in-range” location). Whether this attraction and subsequent relocation is caused by instilling a sense of security and safety in the animal of interest in the “in-range” location (e.g., a flock of Canada geese decoys located at the edge of a pond), or by appealing to the animal of interest's mating or hunting instincts (e.g., a hen to attract a tom turkey, or a chicken decoy to attract a predator coyote) or, for that matter, any other visually triggered attraction mechanism, the relocation of the animal of interest from the out-of-range location to the in-range location significantly increases a hunter's chance of killing the animal of interest, whether that kill be achieved by gunshot, bow and arrow, trapping, or other means. The intended relocation might also be sought for reasons other than hunting, such as animal watching or study (observation), and photography.

The traditional use of conventional decoys, however, has not been without its problems. Most notable of these problems may be that attributable to the stationary nature of conventional decoys. As any animal mimicked by a decoy would typically move when in the “in-range” location and at the times that the decoy is positioned, a stationary decoy may not display as life-like an appearance as may be necessary to attract the animal of interest, and thus may compromise the decoy's effectiveness in “bringing down game.” In response, several decoy moving products able to mimic feeding, mating, typical response, or other motions, whether controlled or not, have been introduced to the market.

Although perhaps more effective in attracting an animal of interest than their stationary predecessors, the conventional decoy moving products are also not without significant disadvantages. Most significant among them is their inability to mimic actual movements of live birds on the ground.

### SUMMARY OF THE INVENTION

The present invention includes a variety of aspects which may be selected in different combinations based upon the particular application or needs to be addressed. In one basic form, certain embodiments of the invention focus on a moving bird decoy apparatus that may comprise a bird decoy body defining a cavity and to which are attached two wings and a decoy head; and an automated wing motion element established at least partially within said cavity and capable of moving two wings to simulate wing stretching motions. Such wing motion may also effect a rocking back and forth motion of the entire decoy, thereby adding to the “live” appearance of the decoy.

It is a goal of at least one embodiment of the invention to provide a decoy moving apparatus and related method that improve relative to prior art the “live” appearance of a bird decoy, thereby enhancing the attractive effect of moving bird decoys.

Naturally, further objects of the invention are disclosed throughout other areas of the specification and claims.

### BRIEF DESCRIPTION OF THE DRAWINGS

The following drawings represent certain embodiment(s) only and do not limit the scope of the inventive technology, as such scope is governed by the claims themselves appearing below.

FIGS. 1a-1g show plan views of a schematic illustrating the various wing positions during operation of certain decoy embodiments in which all forward-most wing positions are the same and all rearward-most wing positions (other than the final positions) are different.

FIGS. 2a-2g show plan views of a schematic illustrating the various wing positions during operation of certain decoy embodiments in which in which at least some forward-most wing positions are different, and at least some of the rearward-most wing positions are different.

FIG. 3 shows a top view of the automated wing motion element of at least one embodiment of the invention (some parts such as the arms are in phantom to allow illustration of parts otherwise hidden). The wings are in a staggered position only for display purposes.

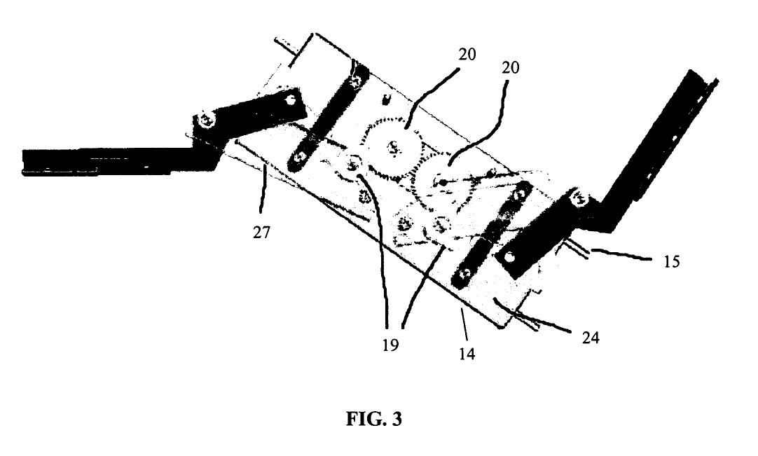

FIG. 4 shows a top view of the automated wing motion element of at least one embodiment of the invention, in addition to showing a battery power source.

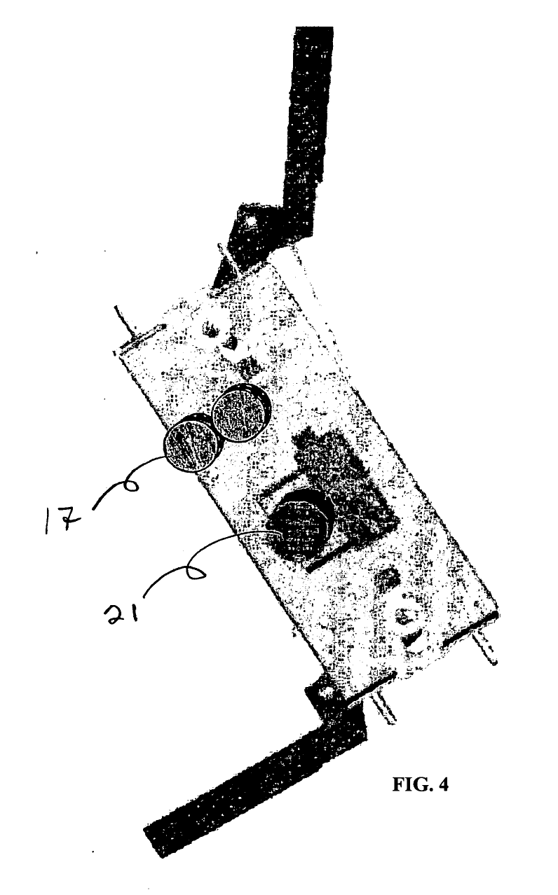

FIG. 5 shows a side view of the automated wing motion element of at least one embodiment of the invention.

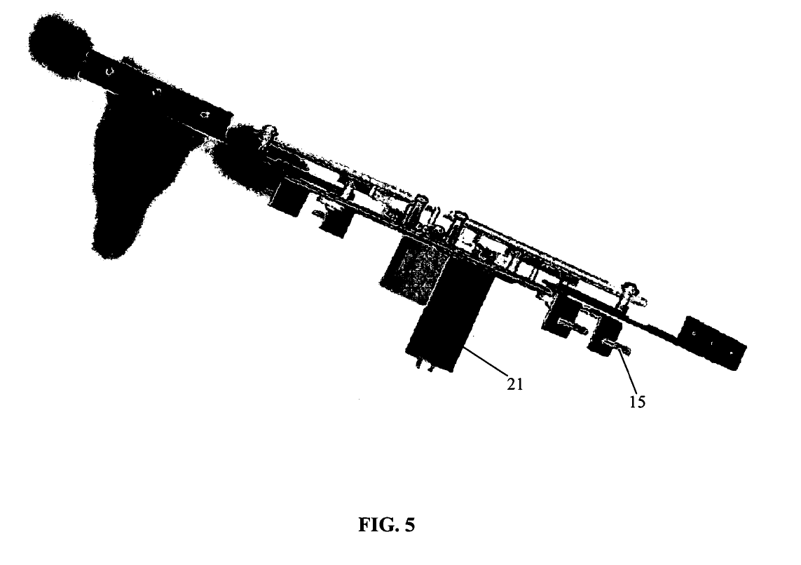

FIG. 6 shows a detailed top view of the automated wing motion element of at least one embodiment of the invention (some parts such as the arms are in phantom to allow illustration of parts otherwise hidden). The wings are in positions as might be found during operation of the apparatus.

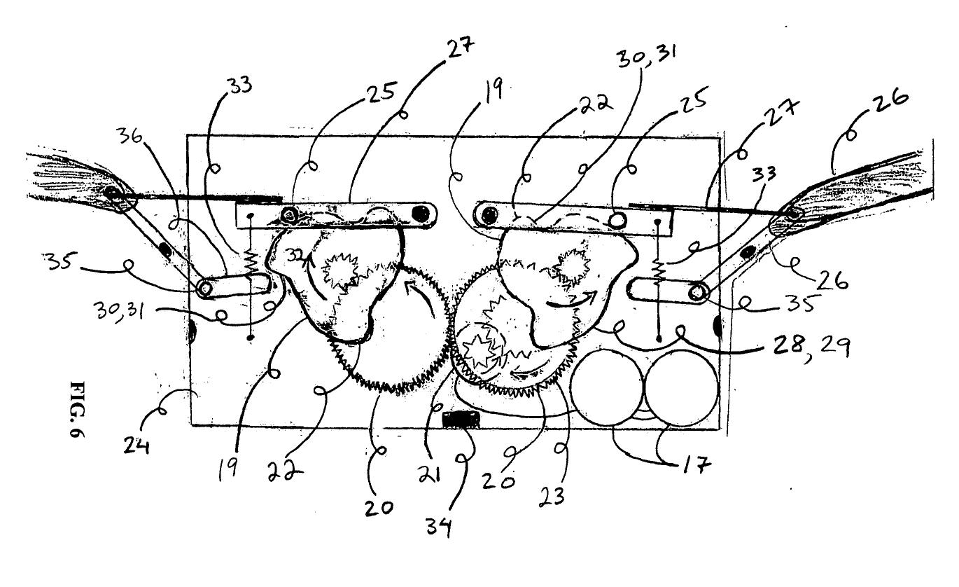

FIG. 7 shows a top view of the automated wing motion element and a decoy body of at least one embodiment of the invention (the decoy body is in phantom to allow illustration of parts otherwise hidden). The wings are in a staggered position only for display purposes.

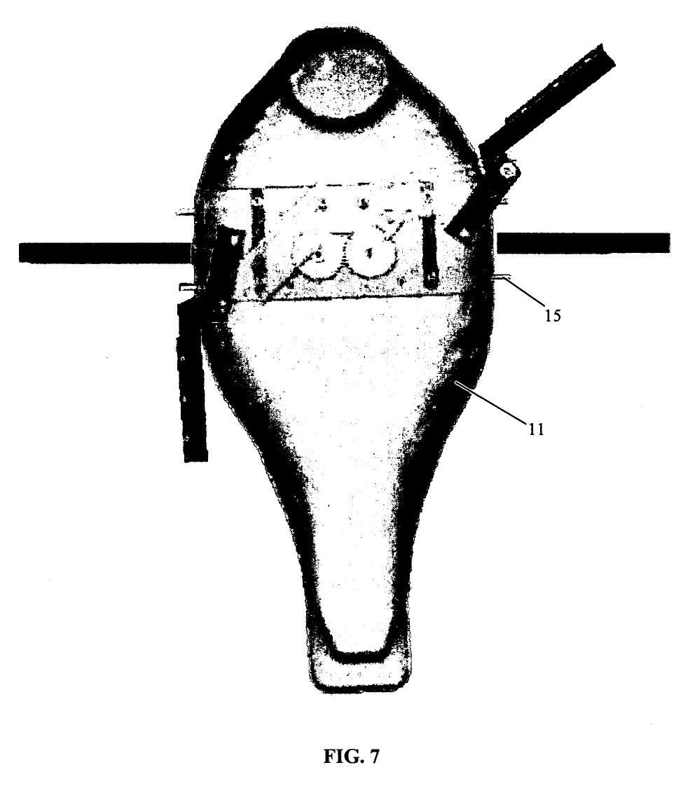

FIG. 8 shows FIG. 7 shows a perspective view of the automated wing motion element and a decoy body of at least one embodiment of the invention (the decoy body is in phantom to allow illustration of parts otherwise hidden).

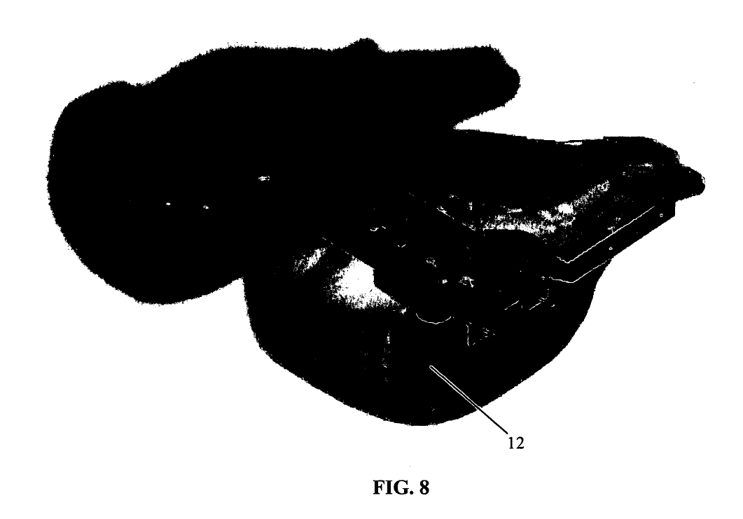

FIG. 9 shows a wireless remote control element, an electric power source (a battery) and a free-standing, full body decoy in which is housed the automated wing motion element, as may be found in at least one embodiment of the invention.

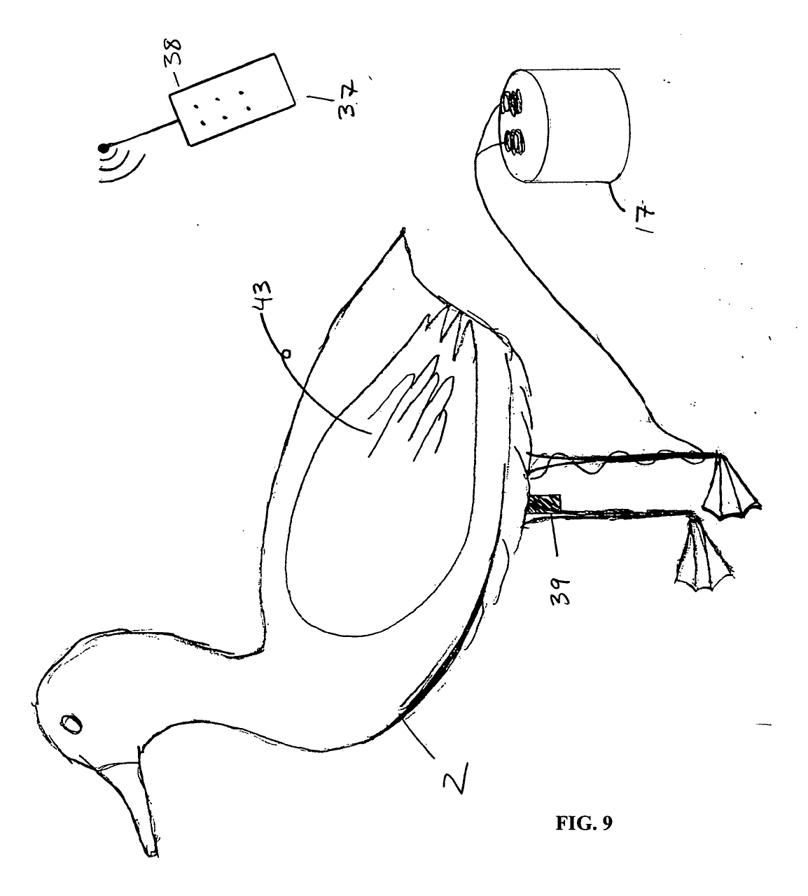

FIG. 10 shows at least one embodiment of the invention having a battery powered, post-supported decoy in which is housed the automated wing motion element.

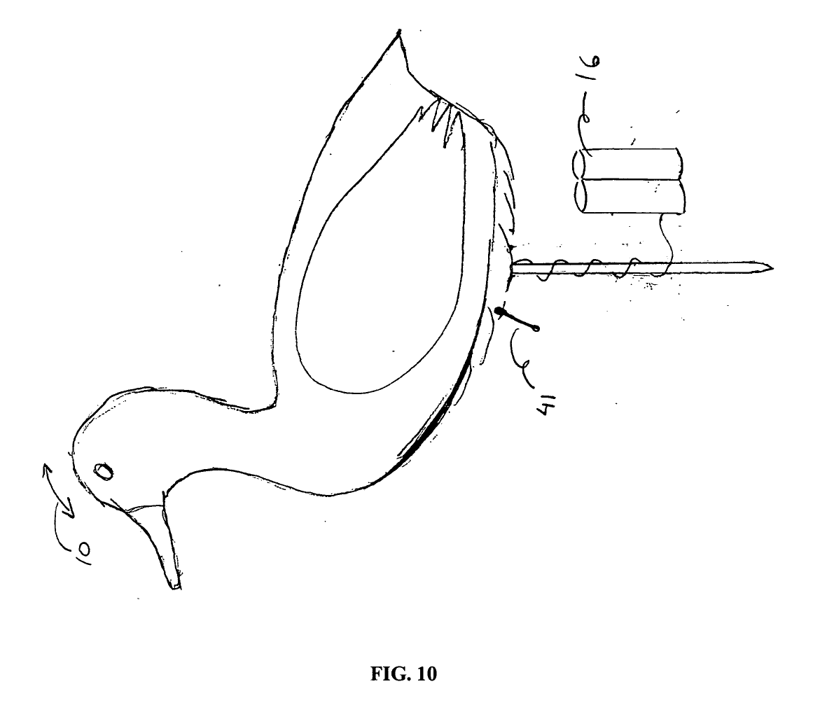

FIG. 11 shows a wired remote control element, an pneumatic power source and a base supported, full body decoy in which is housed the automated wing motion element, as may be found in at least one embodiment of the invention.

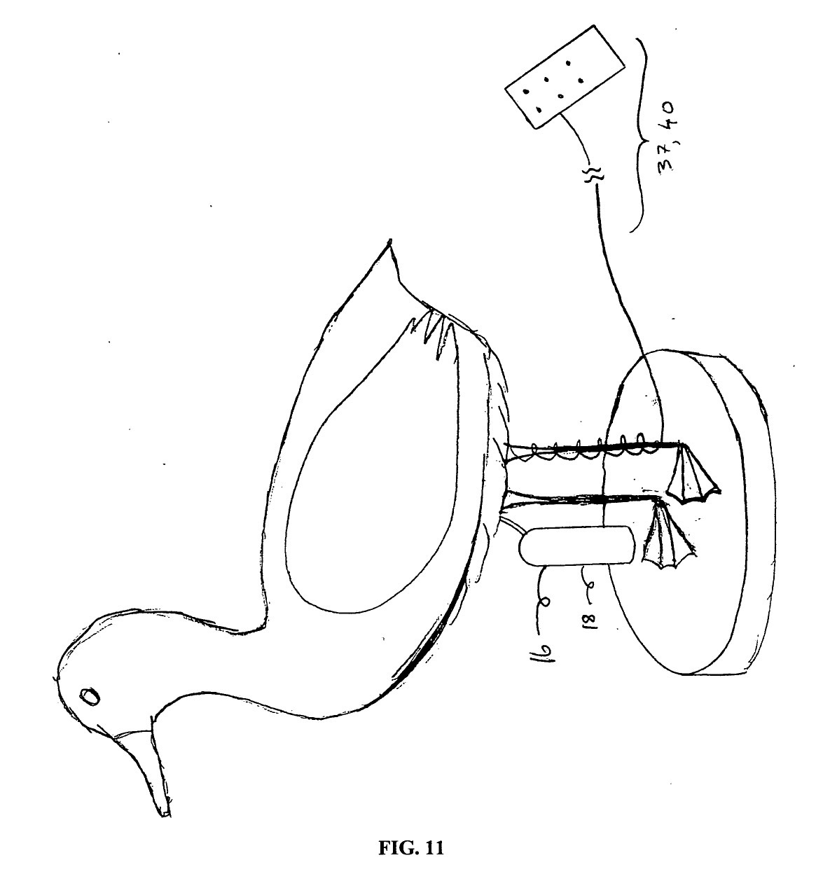

### DETAILED DESCRIPTION OF THE PREFERRED EMBODIMENTS

As mentioned earlier, the present invention includes a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, and applications. Further, this description should further be understood to support and encompass descriptions and claims of all the various embodiments, systems, techniques, methods, devices, and applications with any number of the disclosed elements, with each element alone, and also with any and all various permutations and combinations of all elements in this or any subsequent application.

Embodiments of the inventive technology may involve methods or apparatus relative to moving the wings 1 of a bird decoy 2, which may include waterfowl decoys (including but not limited to goose, duck and other decoys such as Canadian goose decoys, snow goose decoys, specked goose decoys, swans, mallard drake decoys, mallard hens, wood duck drake decoys, wood duck hen decoys, pigeon decoys, and pintail decoys), in addition to owls. In at least one embodiment of the inventive technology, an inventive method involves mimicking the wing stretching motion that birds exhibit on the ground (often after having recently landed from flight). Such motion involves, generally, motion of the wings in tandem.

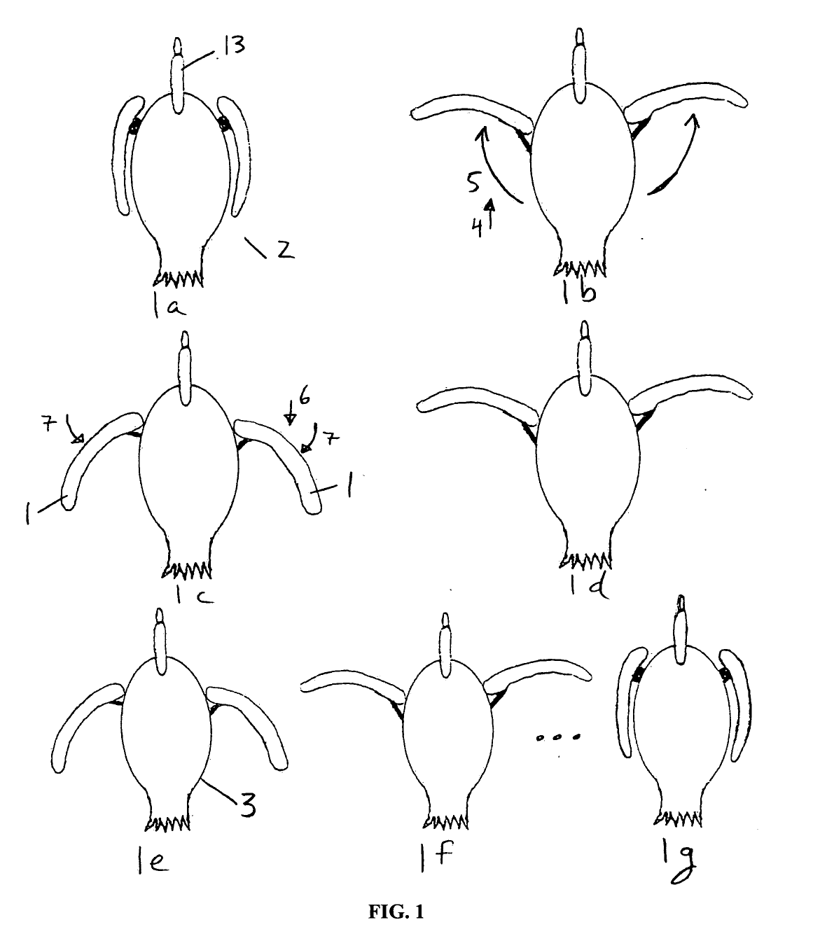

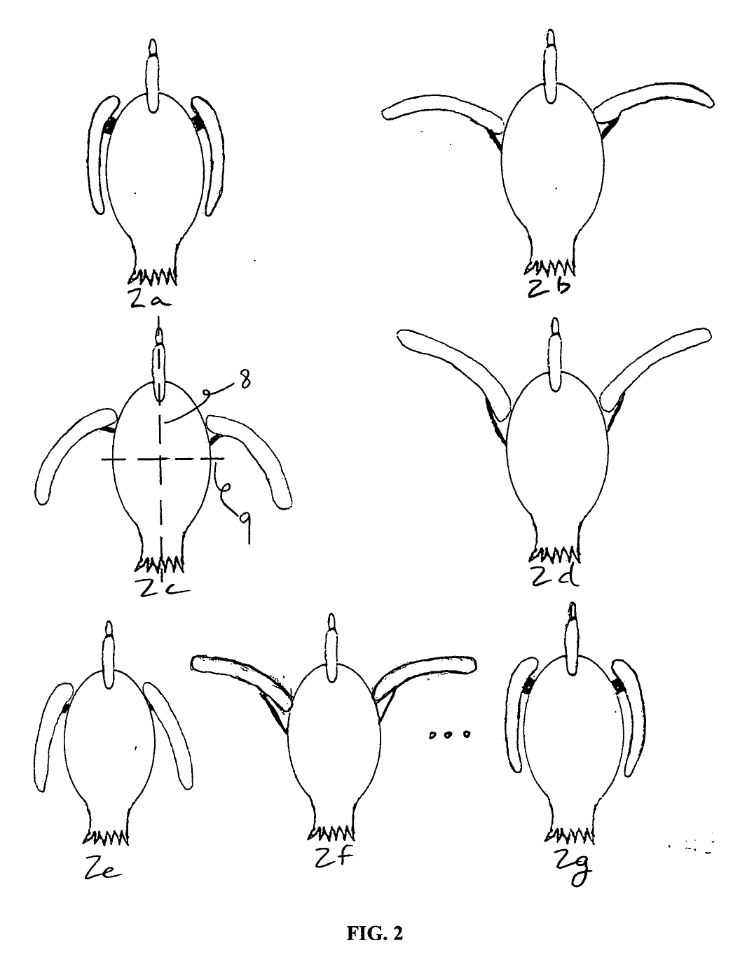

Initially, the motion initiates from start positions (each wing is in a start position as in FIGS. 1a and 2a), which is typically a parked position (again, see FIGS. 1a and 2a) where the wings are relatively in a rearward position and tight against the bird decoy's body. Indeed, each wing may be more proximate a decoy body outer surface 3 than at any other time during wing motion. At least one embodiment of the inventive technology involves non-manually (e.g., via electric power) moving the wings of a decoy in a forward direction 4 (relative to the decoy) from the start positions through a first wing sweep 5 to positions that are the most forward for that wing sweep (i.e., first wing sweep forward-most positions—see FIGS. 1b and 2b). As should be understood, the term plural term positions is used because each wing is moved to its own respective position. The wings may then be non-manually moved from the first wing sweep forward most positions in a rearward direction 6, through a second wing sweep 7 to positions that are the most rearward for that wing sweep (i.e., second wing sweep rearward-most positions—see FIGS. 1c and 2c). Continuing in this fashion, the wings may then be non-manually moved to third wing sweep forward-most positions (see FIGS. 1d and 2d). The motion may at any point hereafter (e.g., eventually) terminate upon the non-manual movement of the wings to final positions (see FIGS. 1g and 2g), which may be the same as the start positions. However, in preferred embodiments, the motion continues through several more wing sweeps (see ellipses in FIGS. 1 and 2) before the wings are returned to their start positions, at which point all motion of the wings may be terminated.

As likely inferred by the reader, the rearward-most positions for a respective wing sweep (other than the final wing sweep) are not as rearward as the rearward-most positions for the final wing sweep (typically, the start positions—see FIGS. 1g and 2g). Indeed, preferred embodiments involve moving the wings through at least ten sweeps before the final sweep returns the wings to their start positions.

It should also be understood that in preferred embodiments, the wings positions (e.g., first wing sweep forward most positions) are mirror image symmetric (e.g., where points on a wing are the same distance from a longitudinal axis 8 and from a transverse axis 9 through the center of the decoy) as are analogous points on the opposite wing. Also, respective positions of the wings are opposite one another (e.g., the positions of the wings in rear parked positions are on opposite sides of a longitudinal axis of the bird). Further, in preferred embodiments, all of the forward-most positions of different wing sweeps (e.g., odd-numbered wing sweeps as in FIGS. 1b and 1d) are the same (see FIG. 1, generally), as are all of the rearward-most positions of different wing sweeps other than the final wing sweep (e.g., non-final, even-numbered wing sweeps as in FIGS. 1c and 1e). However, this is not a required feature as shown by FIG. 2, and may be accomplished by lobes of cams (see discussion below) that extend to different radial lengths. However, as mentioned, the inventive technology is certainly broad enough to cover apparatus and methods that do not exhibit such features.

In order to more closely mimic a live bird's actual moving behavior on the ground, certain embodiments of the invention exhibit not only the aforementioned wing stretching motions, but also a simultaneous movement of the entire bird decoy. Specifically, certain embodiments may include a back and forth rocking motion 10 of the bird decoy, perhaps about a horizontal axis that passes through a point of contact of the decoy with the ground (e.g., the decoy feet, a post, or a base). Such motion may be effected merely as an physical response to the aforementioned wing motion—e.g., when a forward wing flap occurs (e.g., from FIG. 1c to FIG. 1d, or from FIG. 2c to FIG. 2d), basic concepts of physics may demand that the entire body compensate by rotating (e.g., rocking) in a rearward direction if it is not adequately supported against such rotation. Likewise, a rearward wing flap may effect a forward rock of the decoy 2. In this way, the rocking of the bird decoy in a back and forth motion may be performed as a result of the steps of moving the wings. Such superimposition of motion may further add to the “live” appearance and thus the attractive effect of the decoy. The superimposed motions of the wing and the entire decoy body can be viewed in Exhibit A hereby incorporated by reference), which is a disc showing a video of an embodiment of the inventive decoy apparatus and methods.

In at least one embodiment of the invention, a moving bird decoy apparatus may comprise a bird decoy body 11 defining a cavity 12 and to which are attached two wings and a decoy head 13, an automated wing motion element 14 established at least partially within the cavity (perhaps with attachment elements 15) and powered by a power source 16. The automated wing motion element itself may be capable of moving two wings of the bird decoy in the aforementioned fashion. The power source is a general term and may include either an electrical power source 17 (e.g., a battery, an electric generator, or a solar power source), or a pneumatic power source 18 (e.g., a compressed canister of air and necessary accessories thereto such as fluid conveyance tubes), as but two examples. Where a battery (a broad term that includes single and plural individual batteries as may be found in a battery pack) is used, this battery may be hidden from live bird view by placing it under the decoy or by placing it in a cavity defined by the decoy body (e.g., alongside the automated wing motion element). Of course, the apparatus may comprise wires in the case of electric powered embodiments. Where pneumatic power is used, the automated wing motion element may be fluidicly responsive thereto, as the compressed fluid (e.g., compressed air) may actuate the wing motion controlled by the automated wing motion element. Automated is a general term that generally includes operation that is, at least in large part, non-manual. Non-manual motion, of course, implies a movement force that is other than human and that is not applied by human hands. As such, a process or apparatus can be automated where it involves one or more manual steps (e.g., manually hitting a start button), as long as the majority of the wing movement is non-manual.

The automated wing motion element may include geared cams 19 that are either driven directly by an electric motor or pneumatically, or engaged with a drive gear(s) 20 which may be driven directly by an electric motor 21 or pneumatically. Where one drive gear is directly engaged with an electric motor, that drive gear may be referred to as the primary drive gear 23. Each cam may at least partially control the motion of one wing by lobes 22 that form a part of each cam. The automated wing motion element may further include a base 24.

Each lobe may contact an arm part (e.g. a post) 25 of an arm 27 to which a wing 26 is attached and may have a forward wing motion causing slope 28 (e.g., a gradual slope 29) on one side and a rearward wing motion causing slope 30 (e.g., a steep slope 31) on the opposite side. When the cam is rotating such that the first part of the lobe that contacts the contacting arm part is the forward wing motion causing slope (such cam motion will be nominated apparatus operation rotation and indicated by arrow 32), the forward wing motion causing slope will cause the wing to move forward and the rearward wing motion causing slope will cause the wing to move rearward. The forward wing motion causing slope may effect a forward motion of a wing against a rearward bias (e.g., which may be effected by a bias element 33 such as a spring or elastic band attached to the wings or any arms that exist). The rearward wing motion causing slope may be shaped to effect a rearward motion of the wing, perhaps in that as a lobe slides against the arm part (or wing part) such as post 25 and reaches the rearward wing motion causing slope, the obstruction to rearward motion that otherwise would be effected by the rearward bias is removed (eventually, as the cam's rotation proceeds) and the rearward bias force dominates.

The rearward wing motion causing slope of lobes may be shaped such that it has shape sufficient to “catch” an arm part (or other contacting part) when the cam rotates in a direction opposite that of the apparatus operation rotation (such direction may be nominated a termination rotation), thereby ending the sliding motion of the cam relative to the contacting part. Indeed, lobes of the cam may take on a curling wave type profile. Such “catching” is a step of one way in which termination of the wing motion may be achieved, and can in effect lead to a pushing of the wings rearward toward a final position (which may be the same as the start position). This “push” may be at least partially in the direction of bias, but may be beyond (e.g., as the wing nears its final position) any bias “assisting” effect after a certain point. Such reversal of direction of the cam to initiate the termination of wing motion may be caused by a microprocessor 34 (e.g., a programmable microprocessor, which includes a pre-programmed microprocessor), perhaps after a certain period of time (which may be programmable and adjustable) or after a certain number of wing sweeps (which also may be programmable and adjustable).

To complete the termination of operation of the apparatus (e.g., to end wing motion) or to simply conserve power, there should also be a manner by which power (e.g., electric or pneumatic) is shut down. In at least one embodiment of the invention, such a shut down is initiated by a magnetic sensor's determination that at least one of the wings is sufficiently near the decoy body. However, it may be necessary (perhaps using a microprocessor programmed function) to inactivate such sensor until a certain time after initiation of the wing motion, or the sensor might shut off the power once it starts. As with all microprocessor programmed functionalities that may form a part of at least one embodiment of the inventive technology, such programs are easily within the ordinary skill of a programmer.

Although certain embodiments may involve direct contact of the cam with a part of the wing, preferred embodiments involve direct contact of the cam with a part of an arm (a post, e.g.), where the arm itself is attached to the wing and transfers moving force to the wing. Such design may enhance the lifelike appearance of the wing motion. What may further enhance the life-like appearance of the wing motion may be placement of a pivot point 35 around which the wing may rotate in an aperture, thereby enabling the pivot point itself to slide within the aperture 36. Such a changeable wing pivot point may shift along a line defined by the aperture during movement of the wings.

Various embodiments of the inventive technology may be directed to alternative manners of turning on the apparatus. For example, in at least one embodiment, the automated wing motion element may include a remote control element 37 (e.g., a wireless transmitter 38 and receiver 39; or a wired remote control element 40) usable to remotely start the apparatus. At least one embodiment may include simply a toggle switch 41 (e.g., on the underside of the decoy) that may be used to start the apparatus or at least prepare it to receive a remote signal. It should be understood that turning on the apparatus does not necessarily mean that the wings immediately start moving, as there may be a delay function (perhaps programmed in a microprocessor 34). Further, after the wings move for a period of time and then cease moving, the apparatus may remain in a relax mode (e.g., for any period of time, such as 30 seconds, or two minutes, as but two examples) until it automatically restarts again. Such cycling may continue for a predetermined time or number of cycles. Or, it may be such that a start button 42 (e.g., a toggle switch or on a remote control transmitter) may need to be hit or flipped every time a wing stretching motion is desired.

Other features may include feather detailing 43 on the wings, head and/or body of the decoy. It should also be noted that in some cases the automated wing motion element may be retrofitted into decoys (e.g., full body decoys, including post supported decoys) purchasable from retailers. Such retrofitting may require some modification of the decoys, and may be accomplished by either a purchaser or by a manufacturer. The manufacturer may also or instead manufacture its own decoy (e.g., body, head and wings, and perhaps feet or post) in order that, e.g., the automated wing motion element may be incorporated thereon and sold as a functioning unit.

As can be easily understood from the foregoing, the basic concepts of the present invention may be embodied in a variety of ways. It involves both decoy wing moving techniques as well as devices to accomplish the appropriate decoy wing motion. In this application, the decoy wing movement techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this patent application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Not only are apparatus claims included for the device described, but also method or process claims are included to address the functions the invention and each element performs. Neither the description nor the terminology is intended to limit the scope of the claims in this or any subsequent patent application.

It should also be understood that a variety of changes may be made without departing from the essence of the invention. Such changes are also implicitly included in the description. They still fall within the scope of this invention. A broad disclosure encompassing both the explicit embodiments shown, the great variety of implicit alternative embodiments, and the broad methods or processes and the like are encompassed by this disclosure and may be relied in order to support one or more of the claims of this or any subsequent patent application. With this understanding, the reader should be aware that this disclosure is to be understood to support as broad a base of claims as deemed within the applicant's right that are designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “cam” should be understood to encompass disclosure of the act of “camming”—whether explicitly discussed or not—and, conversely, were there effectively disclosure of the act of “camming”, such a disclosure should be understood to encompass disclosure of a “cam” and even a “means for camming” Such changes and alternative terms are to be understood to be explicitly included in the description.

Any acts of law, statutes, regulations, or rules mentioned in this application for patent; or patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Patent Application or other information statement or list of references filed with the application are hereby appended and hereby incorporated by reference, however, as to each of the above, to the extent that such information or statements incorporated by reference might be considered inconsistent with the patenting of this inventions such statements are expressly not to be considered as made by the applicants.

Thus, the applicants should be understood to have support to claim and make a statement of invention to at least: i) each of the plant punch devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, and xii) each potentially dependent claim or concept as a dependency on each and every one of the independent claims or concepts presented; xiii) each feature, component, and step shown as separate and independent inventions; and xiv) the various combinations and permutations of each of the above and of any elements of each claim. In this regard it should be understood that for practical reasons and so as to avoid adding potentially hundreds of additional claims, the applicant has presented the claims with initial dependencies only. Support should be understood to exist to the degree required under new matter laws—including but not limited to European Patent Convention Article 123(2) and United States Patent Law 35 USC 132 or other such laws—to permit the addition of any of the various dependencies or other elements presented under one independent claim as dependencies or elements under any other independent claim.

With regard to claims whether now or later presented for examination, it should be understood that for practical reasons and so as to avoid great expansion of the examination burden, the applicant may at any time present only initial claims or perhaps only initial claims with only initial dependencies. Support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

Both all priority filing(s) and the claims set forth later in this specification are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon. The claims initially presented are to be understood as also stating in this textual section of the specification, clauses and subject matter that are expressly designated by the applicant to be part of the description of embodiments of the invention. They may be used by the applicant to support any later claim(s) recited, amended, or reinserted in this patent application and may be used to support any claims recited in any subsequent continuation, continuation-in-part, or division patent application. Further, even if subsequently amended, cancelled, or otherwise altered, the claims originally set forth in this and the priority filing(s) are hereby incorporated by reference as part of this section, and the applicant expressly reserves the right to use all of or a portion of any of the content of such as additional description to support any claim or element, any amendment, and any component thereof. The content of this section (both listed and incorporated by reference) shall survive during the entire pendency of this application including any subsequent continuation, division, or continuation-in-part thereof or any reissue or extension thereon.

Finally, it should be understood that the term “at least one” as used in the description and claims is not intended nor used in this disclosure to mean that other claims or descriptions not incorporating the “at least one” language cannot further include one or more like elements and the language “at least one” is not intended nor used to change “open-ended” claims, inherently including devices or methods having additional elements or steps apart from those claimed, into “closed-ended” claims wherein devices or methods having additional elements would not be covered by such claims. Further, if or when used, the use of the transitional phrase “comprising” (or its equivalent in Australia and the like, “including”) is used to maintain the “open-end” claims herein, according to traditional claim interpretation. Thus, unless the context requires otherwise, it should be understood that the term “comprise”, “include” (if or when inserted), or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. Further, this application should be considered to support claims as follows: methods substantially as described hereinbefore and with reference to any of the accompanying examples, and apparatus substantially as described hereinbefore and with reference to any of the accompanying examples.

1. A bird decoy wing movement method, comprising the steps of:
establishing in a desired position a bird decoy having a bird decoy body, head and wings;
non-manually moving said wings of said bird decoy in a forward direction from start positions to first wing sweep forward-most positions;
non-manually moving said wings from said first wing sweep forward-most positions in a rearward direction to second wing sweep rearward-most positions that are different from said start positions and said first wing sweep forward-most positions;
non-manually moving said wings from said second wing sweep rearward-most positions in a forward direction to third wing sweep forward-most positions;
non-manually moving said wings from said third wing sweep forward-most positions in a rearward direction to fourth wing sweep rearward-most positions that are different from said start positions and said third wing sweep forward-most positions; and
eventually non-manually moving said wings to final positions.

2. A bird decoy wing movement method as described in claim 1 wherein said step of eventually non-manually moving said wings to said final positions comprises the step of eventually non-manually returning said wings to said start positions.

3. A bird decoy wing movement method as described in claim 1 wherein said step of non-manually moving said wings of said bird decoy in a forward direction from start positions to first wing sweep forward-most positions comprises the step of non-manually moving said wings of said bird decoy in a forward direction from start positions to positions that are mirror image symmetric.

4. A bird decoy wing movement method as described in claim 1 wherein said step of non-manually moving said wings from said first wing sweep forward-most positions in a rearward direction to second wing sweep rearward-most positions comprises the step of non-manually moving said wings from said first wing sweep forward-most positions in a rearward direction to positions that are mirror image symmetric.

5. A bird decoy wing movement method as described in claim 1 wherein said step of non-manually moving said wings from said second wing sweep rearward-most positions in a forward direction to third wing sweep forward-most positions comprises the step of non-manually moving said wings from said second wing sweep rearward-most positions in a forward direction to positions that are mirror image symmetric.

6. A bird decoy wing movement method as described in claim 1 wherein said step of non-manually moving said wings from said third wing sweep forward-most positions in a rearward direction to fourth wing sweep rearward-most positions comprises the step of non-manually moving said wings from said third wing sweep forward-most positions in a rearward direction to positions that are mirror image symmetric.

7. A bird decoy wing movement method as described in claim 1 wherein said step of non-manually moving said wings from said second wing sweep rearward-most positions in a forward direction to third wing sweep forward-most positions comprises the step of non-manually moving said wings from said second wing sweep rearward-most positions in a forward direction to positions that are the same as said first wing sweep forward-most positions.

8. A bird decoy wing movement method as described in claim 1 wherein said step of non-manually moving said wings from said third wing sweep forward-most positions in a rearward direction to fourth wing sweep rearward-most positions comprises the step of non-manually moving said wings from said third wing sweep forward-most positions in a rearward direction to positions that are the same as said second wing sweep rearward-most positions.

9. A bird decoy wing movement method as described in claim 1 wherein each of said steps of non-manually moving said wings comprises the steps of non-manually moving said wings about substantially vertical axes.

10. A bird decoy wing movement method as described in claim 1 wherein said step of non-manually moving said wings from said first wing sweep forward-most positions in a rearward direction to second wing sweep rearward-most positions that are different from said start positions and said first wing sweep forward-most positions comprises the step of non-manually moving said wings from said first wing sweep forward-most positions in a rearward direction to second wing sweep rearward-most positions that are between said start positions and said first wing sweep forward-most positions

11. A bird decoy wing movement method as described in claim 1 wherein said step of non-manually moving said wings from said third wing sweep forward-most positions in a rearward direction to fourth wing sweep rearward-most positions that are different from said start positions and said third wing sweep forward-most positions comprises the step of non-manually moving said wings from said third wing sweep forward-most positions in a rearward direction to fourth wing sweep rearward-most positions that are between said start positions and said third wing sweep forward-most positions.

12. A bird decoy wing movement method as described in claim 1 wherein said step of non-manually moving said wings of said bird decoy in a forward direction from start positions to first wing sweep forward-most positions comprises the steps of non-manually moving said wings of said bird decoy in a forward direction from parked positions where said wings are each more proximate a decoy body outer surface established by said decoy body than at any other time during wing motion.

13. A bird decoy wing movement method as described in claim 1 further comprising the step of rocking said bird decoy in a back and forth motion.

14. A bird decoy wing movement method as described in claim 13 wherein said step of rocking said bird decoy in a back and forth motion is performed as a result of said steps of moving said wings.

15. A bird decoy wing movement method as described in claim 1 wherein every forward-most position is the same.

16. A bird decoy wing movement method as described in claim 1 wherein all rearward-most positions other than said start positions and other than said final positions are the same.

17. A bird decoy wing movement method as described in claim 1 wherein said start positions are further rear than each of said second wing sweep rearward most positions and said fourth wing sweep rearward most positions.

18. A bird decoy wing movement method as described in claim 1 further comprising the step of non-manually moving said wings from said fourth wing sweep rearward-most positions in a forward direction to fifth wing sweep forward-most positions.

19. A bird decoy wing movement method as described in claim 18 further comprising the steps of: non-manually moving said wings from said fifth wing sweep forward-most positions in a rearward direction to sixth wing sweep rearward most positions that are between said start positions and said fifth wing sweep forward-most positions, and non-manually moving said wings from said sixth wing sweep rearward-most positions to seventh wing sweep forward-most positions.

20. A bird decoy wing movement method as described in claim 1 wherein said steps of non-manually moving wings comprises the steps of electrically moving wings.

21. A bird decoy wing movement method as described in claim 1 wherein said steps of non-manually moving wings comprises the steps of pneumatically moving wings

22. A bird decoy wing movement method as described in claim 1 further comprising the step of wireless remote control activating said step of non-manually moving said wings of said bird decoy in a forward direction from start positions to first wing sweep forward-most positions to initiate bird wing motion.

23. A bird decoy wing movement method as described in claim 1 further comprising the step of wired remote control activating said step of non-manually moving said wings of said bird decoy in a forward direction from start positions to first wing sweep forward-most positions to initiate bird wing motion.

24. A moving bird decoy apparatus, comprising:
a bird decoy body defining a cavity and to which are attached two wings and a decoy head; and
an automated wing motion element established at least partially within said cavity and capable of moving two wings of said bird decoy from rear parked positions forward to first wing sweep forward-most positions and then rearward to second wing sweep rearward most positions that are between said first wing sweep forward most positions and said rear parked positions, and then forward to third wing sweep forward-most positions, and eventually back to said rear parked positions,
wherein said rear parked positions of each of said wings are opposite one another, said forward most positions of each of said wings are opposite one another, and said intermediate positions of each of said wings are opposite one another, and
wherein said moving bird decoy apparatus further comprises a power source that powers said automated wing motion element.

25. A moving bird decoy apparatus as described in claim 24 wherein said automated wing motion element is also capable of moving said two wings rearward from said third wing sweep forward-most positions to fourth wing sweep rearward-most positions that are between said rear parked positions and said third wing sweep forward-most positions, and then to fifth wing sweep forward most positions before eventually returning said wings back to said rear parked positions.

26. A moving bird decoy apparatus as described in claim 25 wherein said second wing sweep rearward most positions are the same as said fourth wing sweep rearward most positions.

27. A moving bird decoy apparatus as described in claim 24 wherein said first wing sweep forward-most positions are the same as said second wing sweep forward most positions and said third wing sweep forward-most positions.

28. A moving bird decoy apparatus as described in claim 24 wherein said automated wing motion element is capable of moving said bird decoy body in a back and forth motion.

29. A moving bird decoy apparatus as described in claim 28 wherein said back and forth motion is accomplished by said wing motion.

30. A moving bird decoy apparatus as described in claim 24 wherein said bird decoy body is a water fowl decoy body.

31. A moving bird decoy apparatus as described in claim 30 wherein said water fowl decoy body is a goose decoy body.

32. A moving bird decoy apparatus as described in claim 30 wherein said water fowl decoy body is a duck decoy body.

33. A moving bird decoy apparatus as described in claim 24 wherein said bird decoy body is an owl decoy body.

34. A moving bird decoy apparatus as described in claim 24 wherein said power source comprises an electrical power source.

35. A moving bird decoy apparatus as described in claim 34 further comprising wires connecting said electrical power source to said automated wing motion element.

36. A moving bird decoy apparatus as described in claim 34 wherein said electrical power source comprises at least one battery.

37. A moving bird decoy apparatus as described in claim 36 wherein said at least one battery is established in said cavity.

38. A moving bird decoy apparatus as described in claim 34 wherein said electrical power source is an electrical generator.

39. A moving bird decoy apparatus as described in claim 24 wherein said power source comprises a pneumatic power source to which said automated wing motion element is fluidicly responsive.

40. A moving bird decoy apparatus as described in claim 39 wherein said pneumatic power source is established in said cavity.

41. A moving bird decoy apparatus as described in claim 39 wherein said pneumatic power source is established outside of said cavity.

42. A moving bird decoy apparatus as described in claim 24 wherein said automated wing motion element comprises a remote control element usable to remotely activate wing motion.

43. A moving bird decoy apparatus as described in claim 42 wherein said remote control element comprises a wireless remote control element.

44. A moving bird decoy apparatus as described in claim 42 wherein said remote control element comprises a wired remote control element.

45. A moving bird decoy apparatus as described in claim 24 wherein said automated wing motion element simulates wing flapping.

46. A moving bird decoy apparatus as described in claim 24 wherein said automated wing motion element simulates wing stretching.

47. A moving bird decoy apparatus as described in claim 24 wherein said wings exhibit feather detailing.

48. A moving bird decoy apparatus as described in claim 24 wherein said automated wing motion element comprises a base.

48. A moving bird decoy apparatus as described in claim 24 wherein said automated wing motion element comprises two geared cams engaged with at least one drive gear.

50. A moving bird decoy apparatus as described in claim 48 wherein the total number of cams is two.

51. A moving bird decoy apparatus as described in claim 50 wherein each of said cams at least partially controls motion of one wing.

52. A moving bird decoy apparatus as described in claim 48 wherein said at least one geared cam comprises at least two lobes.

53. A moving bird decoy apparatus as described in claim 52 wherein said at least two lobes comprises three lobes.

54. A moving bird decoy apparatus as described in claim 52 wherein each of said lobes has a steep slope on one side and a gradual slope on the opposite side.

55. A moving bird decoy apparatus as described in claim 54 wherein said gradual side effects a forward motion of a wing and said steep slope effects a rearward motion of said wing.

56. A moving bird decoy apparatus as described in claim 48 wherein each of said two geared cams contacts an arm part of an arm to which a wing is attached.

57. A moving bird decoy apparatus as described in claim 56 wherein each of said two geared cams have lobes shaped to slide against said arm part when said two geared cams rotate such that the first part of said lobes that said arm part contacts is a gradual slope of said lobe.

58. A moving bird decoy apparatus as described in claim 57 wherein each of said two geared cams have lobes shaped to catch said arm part when said two geared cams rotate such that the first part of one of said lobes that said arm part contacts is a steep slope of said lobe.

59. A moving bird decoy apparatus as described in claim 56 wherein said part of an arm is a post.

60. A moving bird decoy apparatus as described in claim 56 wherein said arm pivots about an arm pivot axis.

61. A moving bird decoy apparatus as described in claim 56 wherein said wing pivots about a changeable wing pivot point.

62. A moving bird decoy apparatus as described in claim 61 wherein said changeable wing pivot point is along a line defined by an aperture.

63. A moving bird decoy apparatus as described in claim 56 wherein each said arm is biased in a rearward direction by a bias element.

64. A moving bird decoy apparatus as described in claim 63 wherein said bias element comprises a spring attached to each of said arms.

65. A moving bird decoy apparatus as described in claim 24 wherein said automated wing motion element comprises at least one electric motor that drives at least one drive gear.

66. A moving bird decoy apparatus as described in claim 65 wherein said electric motor automatically reverses after a period of time to terminate said wing motion.

67. A moving bird decoy apparatus as described in claim 66 wherein said period of time is predetermined.

68. A moving bird decoy apparatus as described in claim 66 wherein automated wing motion element further comprises a microprocessor that reverses said electric motor after said period of time.

69. A moving bird decoy apparatus as described in claim 68 wherein said period of time is predetermined.

70. A moving bird decoy apparatus as described in claim 68 wherein said period of time is adjustable.

71. A moving bird decoy apparatus as described in claim 24 wherein said automated wing motion element further comprises at least one magnetic sensor.

72. A moving bird decoy apparatus as described in claim 71 wherein at least part of said at least one magnetic sensor is attached to a wing.

73. A moving bird decoy apparatus as described in claim 71 wherein said magnetic sensor acts to shut off said automated wing motion element.

74. A moving bird decoy apparatus as described in claim 24 further comprising attachment elements that attach said automated wing motion element inside said bird decoy body.

75. A moving bird decoy apparatus as described in claim 24 wherein said bird decoy body is a body of a full body decoy.

76. A moving bird decoy apparatus as described in claim 24 wherein said bird decoy body is a body of a post-supported decoy.
